(19) United States
(12) Patent Application Publication
(10) Pub. No.: US 2015/0175105 A1
(43) Pub. Date: Jun. 25, 2015

(54) DRIVE SYSTEM FOR A TRACTION VEHICLE

(71) Applicant: Inekon Group, a.s., Praha (CZ)

(72) Inventor: Ladislav Kyr, Praha (CZ)

(21) Appl. No.: 14/576,850

(22) Filed: Dec. 19, 2014

(30) Foreign Application Priority Data
Dec. 19, 2013 (CZ) 2013-1030

(51) Int. Cl. B60R 16/033; B60R 16/023; B60L 11/18

(52) U.S. Cl. CPC B60R 16/033; B60L 11/1809; B60R 16/023

(57) ABSTRACT

A drive system for a traction vehicle equipped with a current collector, the drive system comprising an electric traction motor, a traction inverter, a traction battery pack, a charger for the battery pack, a coupling member, a current filter, a brake resistor, a brake inverter, a current collector, a electromagnetic interference filter, and a main circuit breaker, the electric traction motor being connected to the traction inverter and the brake resistor being connected to the brake inverter. The drive system further includes a DC rated intermediate circuit being in connection with the main circuit breaker, the brake inverter and the traction inverter on the one hand and with the traction battery pack on the other hand, the latter being connected to said intermediate circuit through an antiparallel combination consisting of the coupling member and the traction battery charger and further through the current filter, said coupling member being composed of a simple power diode.

### CROSS REFERENCE TO RELATED APPLICATION

This application claims priority to Czech Republic Patent Application No. 2013-1030 to Ladislav Kyr entitled “Drive System For A Traction Vehicle” and filed on Dec. 19, 2013, which application is incorporated in its entirety by reference herein.

### FIELD OF THE INVENTION

The present invention relates to a traction drive system for an electric vehicle equipped with a current collector.

### BACKGROUND OF THE INVENTION

The traction drives of electric vehicles are increasingly equipped with traction battery packs which enable the vehicle to be driven without any supply of a trolley voltage to achieve an extended range. A traction drive consists of traction electric motors, a traction inverter, a brake resistor, a brake inverter, a current collector, an electromagnetic interference filter, and a main circuit breaker. Moreover, such a traction drive comprises a traction battery pack, a traction battery charger, and a coupling member arranged between the traction battery pack and the traction inverter.

The use of battery packs makes the traction drive more complex, requiring increased number and sizes of electric leads. In addition, it makes both the communication among the individual elements of the traction drive and the requirements for the related accommodating space more demanding. A specific problem is related to the process of connecting and disconnecting the battery pack depending on whether the same should be discharged (to provide energy), or conversely, recharged (to absorb energy). In accordance with the prior art, direct-acting DC rated contactors are used to fulfil the above function. Alternatively, contactless power switches provided with relatively complex control circuits are used. The main drawback of contactors consists in that the operation thereof cannot be automated and that a certain time lag is unavoidable during every switching action. Similarly, the operation of contactless switches can be automated only to a limited extent and, furthermore, such switches are very expensive.

### SUMMARY OF THE INVENTION

The above drawbacks are eliminated by a drive system for a traction vehicle equipped with a current collector, the drive system comprising an electric traction motor, a traction inverter, a traction battery pack, a charger for the battery pack, a coupling member, a current filter, a brake resistor, a brake inverter, a current collector, a electromagnetic interference filter, and a main circuit breaker, the electric traction motor being connected to the traction inverter and the brake resistor being connected to the brake inverter. The drive system further includes a DC rated intermediate circuit being in connection with the main circuit breaker, the brake inverter and the traction inverter on the one hand and with the traction battery pack on the other hand, the latter being connected to said intermediate circuit through an antiparallel combination consisting of the coupling member and the traction battery charger and further through the current filter, said coupling member being composed of a simple power diode.

The electromagnetic interference filter may be connected between the current collector and the main circuit breaker.

The drive system may further comprise one or more further traction motors and the same or lesser number of traction inverters connected to the DC rated intermediate circuit, wherein preferably the main circuit breaker is shared by all of the constituent drives.

The noise suppression filter and the main circuit breaker may be shared by all of the constituent drive systems.

### BRIEF DESCRIPTION OF THE DRAWINGS

FIG. 1 shows wiring diagram of a first exemplary embodiment of the traction drive for an electric vehicle according to the present invention.

FIG. 2 shows a wiring diagram of a second exemplary embodiment of the traction drive for an electric vehicle according to the present invention.

### DETAILED DESCRIPTION

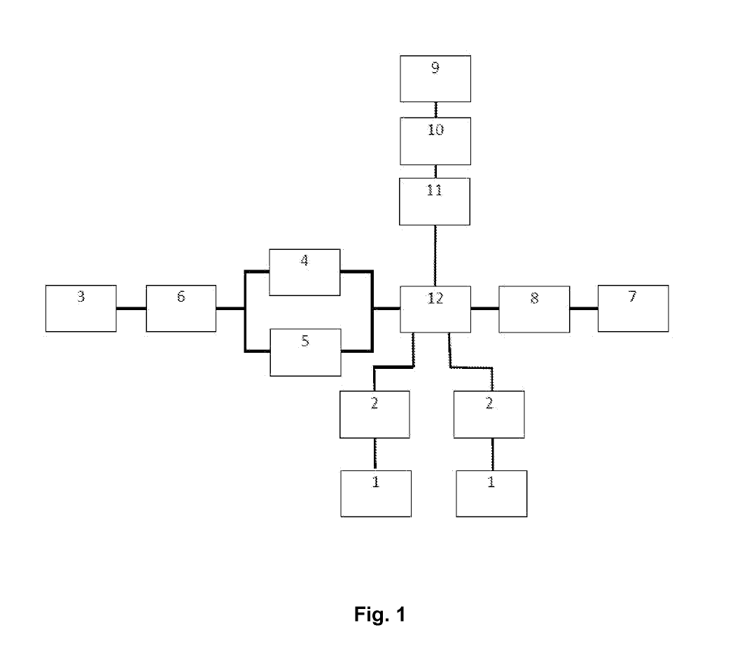

As illustrated in FIG. 1, a traction drive system according to the first exemplary embodiment comprises a DC rated intermediate circuit 12, and two traction inverters 2 connected to the intermediate circuit, a traction motor 1 being in turn connected to each of the traction inverters. Furthermore, a brake inverter 8 is connected to the DC rated intermediate circuit 12, a brake resistor 7 being in turn connected to the brake inverter 8. The following two components are also connected to the DC rated intermediate circuit 12: a main circuit breaker 11, which is interconnected with a current collector 9 via an electromagnetic interference filter 10, and an antiparallel combination consisting of a charger 4 for a traction battery pack 3 and of a coupling member 5 for the same battery pack 3, the antiparallel combination forming along with a current filter 6, a connecting pathway for the battery pack 3.

In the present exemplary embodiment, the coupling member 5 of the battery pack 3 is represented by a simple power diode.

The selected traction battery pack 3 should ensure that the ratio of the nominal voltage of the battery pack 3 to the minimum trolley voltage ranges in the open interval from 0.85 to 1.

The apparatus according to the present invention enables the traction battery pack 3 to perform transitions between the discharging and recharging modes in a fully automatic, contactless manner. This means that the electric current flows either through the charger 4 into the traction battery pack 3 in order to recharge the same or through the coupling member 5 out from the traction battery pack 3 causing the same to discharge.

The traction motors 1 are supplied with power from the traction inverters 2. The electric current flowing through the brake resistor 7 is regulated by the brake inverter 8 while the current from a trolley is carried by the current collector 9 and led through the electromagnetic interference filter 10 and through the main circuit breaker 11 into the DC rated intermediate circuit 12 from where the current can be further drawn by the respective power-consuming components of the traction drive.

The main advantage, which results from the use of the coupling member 5 composed of a simple power diode, consists in contactless transitions between the discharging and recharging modes which simplifies the respective wiring structure, eliminates the necessity of using any auxiliary circuits, which would otherwise be required for controlling the contact switching devices, improves reliability of the entire system, eliminates safety risks related to DC rated switching devices and reduces requirements for both the accommodating space and the labour input.

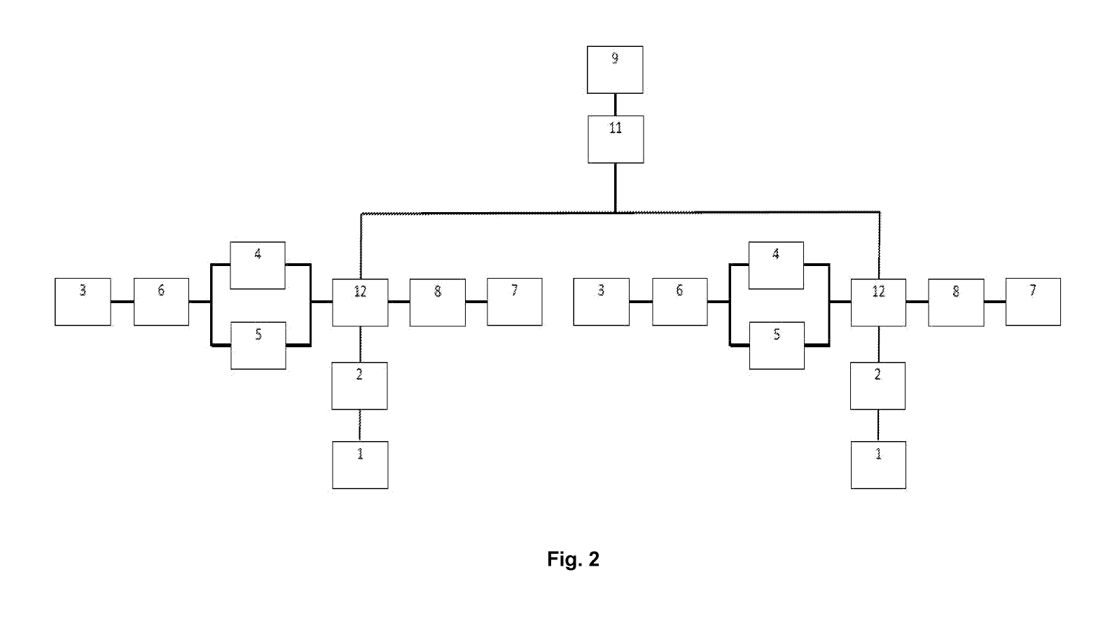

FIG. 2 shows schematically a second exemplary embodiment wherein the drive system according to the invention comprises a pair of DC rated intermediate circuits 12, each being in connection with a traction inverter 2 for feeding a corresponding traction motor 1. Furthermore, one brake inverter 8 is connected to each of the DC rated intermediate circuits 12, one brake resistor 7 being in turn connected to each of the brake inverters. Again, each of the DC rated intermediate circuits 12 is in connection with an antiparallel combination consisting of a charger 4 for a traction battery pack 3 and of a coupling member 5 for the same traction battery pack 3, the antiparallel combination forming along with a current filter 6 a connecting pathway for the battery pack 3. Both the DC rated intermediate circuits 12 are interconnected with a current collector 9 via a main circuit breaker 11, the latter two components being shared by the DC rated intermediate circuits 12 and, thus, also by both of the traction motors 1.

What is claimed is:

1. A drive system for a traction vehicle equipped with a current collector, said drive system comprising:
an electric traction motor,
a traction inverter,
a brake resistor,
a brake inverter,
the electric traction motor being connected to the traction inverter and the brake resistor being connected to the brake inverter,
and the drive system further includes
a traction battery pack,
a charger for the battery pack,
a coupling member said coupling member being composed of a simple power diode,
a current filter,
a current collector,
a electromagnetic interference filter and
a main circuit breaker,
a DC rated intermediate circuit connected with the main circuit breaker, the brake inverter and the traction inverter and being interconnected with the traction battery pack via the current filter and via an antiparallel combination of the coupling member and the traction battery charger.

2. The drive system according to claim 1 wherein the electromagnetic interference filter is connected between the current collector and the main circuit breaker.

3. The drive system according to claim 1, wherein it comprises one or more further traction motors and the same or lesser number of traction inverters connected to the DC rated intermediate circuit.

4. The drive system according to claim 1, wherein the ratio of a nominal voltage of the traction battery pack to a minimum trolley voltage ranges in the open interval from 0.85 to 1.

5. A drive system for a traction vehicle, said drive system comprising several drive systems according to claim 3, wherein the main circuit breaker is shared by all of the constituent drives.

6. A drive system for a traction vehicle, said drive system comprising several drive systems according to claim 1, wherein the noise suppression filter and the main circuit breaker are shared by all of the constituent drives.

7. A drive system for a traction vehicle, said drive system comprising several drive systems according to claim 1, wherein the noise suppression filter and the main circuit breaker are shared by all of the constituent drives.
